(19) United States
(12) Patent Application Publication
(10) Pub. No.: US 2009/0285385 A1
(43) Pub. Date: Nov. 19, 2009

(54) Queuing Systems for Contact Centers

(76) Inventors: Christopher Dunbar, Salthill (IE); Thomas Morris, County Galway (IE); Michael Walsh, County Galway (IE)

Correspondence Address: BARNES & THORNBURG LLP, P.O. BOX 2786, CHICAGO, IL, 60690-2786, US

(21) Appl. No.: 12/119,711

(22) Filed: May 13, 2008

(51) Int. Cl. H04M 3/00

(52) U.S. Cl. 379/266.01

(57) ABSTRACT

Customers queuing in the contact center are provided with the option to request a ticket number. Upon a ticket number being generated for the customer, the customer may disconnect or hang up, and an absentee contact is maintained in a queuing system. This allows the customer to reconnect within a predefined period and regain a place in a queue, possibly at a more advantageous position or at the top of the queue. Alternatively, the customer may reconnect at a less favorable position, but without having to re-enter all customer details in order to be allocated to an appropriate queue.

### TECHNICAL FIELD

This invention relates to queuing systems for contact centers.

### BACKGROUND TO THE INVENTION

Contact centers, including traditionally voice-only call centers as well as multimedia contact centers adapted to handle contacts in other media, employ various strategies to minimize the number of human agents required to service the customer load at any given time, and the skilled person will be aware of diverse approaches to balancing customer loads. Nevertheless, at busy times, most contact centers are forced to queue customers, who are forced to wait on hold, in the context of voice calls, or to remain in proximity to their computer, for example, in the context of instant messaging (IM) sessions or Internet-based video calls.

As used herein the term “on hold” encompasses all waiting scenarios where a customer of a contact center is queuing such that the customer must wait for connection to an agent or another scarce resource of the contact center. The term “customer” denotes a user or client of the contact center, regardless of whether that customer actually has a customer-like relationship with the enterprise providing the contact center service (for example, the “customer” may be a vendor to the contact center business).

In an effort to alleviate frustration when customers are on hold, entertainment or information can be provided (e.g. music, announcements, advertisements, audio feeds, games, queue position information, current expected time to top of queue, etc.) and the customer can be empowered to an extent by providing the option to leave a message or to request a call-back.

However, none of these solutions is entirely satisfactory. The provision of information or entertainment may encourage a customer to wait on hold for a little longer, but customers still grow frustrated sooner or later may abandon their calls.

The provision of a facility to leave a message is unsatisfactory to the customer, as once the message has been left, matters are entirely out of the customer's hands and the customer has no knowledge as to when the contact center will act on the message, if at all. Furthermore, for customers with urgent issues, experience shows that they will not leave a message.

The provision of a call-back facility is unsatisfactory for the contact center because the communications costs are transferred to the contact center. This solution also requires the contact center (which might otherwise deal only with inbound communications) to put in place an infrastructure for outbound call-backs, diverting agents from answering inbound contacts. While it might be thought that it makes little difference whether an agent is tasked with speaking to customers who are inbound contacts or customers who are outbound call-back contacts, experience shows that the call-back may occur when the customer is not free to take the call, or away from their phone or computer, etc., wasting agent time. For inbound contacts, the customer is usually ready to speak to the agent immediately.

An alternative to contact center call-backs is described in commonly assigned U.S. Pat. No. 7,139,381, which describes a system for use by a customer calling from a software-based telephony application or from a programmable telephone. In this system, the customer requests the contact center to send a trigger signal when an agent is available to speak with the customer. The customer's phone is programmed to monitor a communications channel for this trigger signal, and is further programmed to place a call to the contact center when the trigger signal is received. This method is not a complete solution as it is not workable for customers with conventional legacy telephony equipment.

### DISCLOSURE OF THE INVENTION

The invention provides a method of operating a queuing system of a contact center, including the steps of:
maintaining a contact queue for a resource, the queue including contacts associated with customers who are awaiting access to the resource;
providing a customer of the contact center with the option to terminate a communications session with the contact center without losing a benefit of the current communications session;
upon acceptance of the option by the customer, maintaining an absentee contact associated with the customer and with the contact queue, the absentee contact including an identifier suitable to identify a later communications session from the customer;
monitoring for a later communications session between the customer and the contact center; and
upon detecting the later communications session, associating the later communications session with the absentee contact.

The method allows a customer to disconnect from a communications session with a contact center without having to start the entire process again upon resuming contact at a later time. In this way, various advantages can be provided to the customer on resuming contact. For example, data provided by the customer can be saved and associated with the absentee contact, or the queue position can be saved, or the absentee contact can advance within the queue while the customer is disconnected, so that the customer reconnects in a more favorable queue position (or even at the top of the queue).

Unlike in the case of U.S. Pat. No. 7,139,381, this method is not limited to customers with particular equipment. In a voice-based call center, for example, the benefits can be obtained by any customer with any telephone set.

For contact center vendors, and for organizations providing services to their customers using contact centers, the benefits are that they can provide a more favorable user experience, with the result that customers are less frustrated, and this in turn has benefits for the agents who must ultimately speak with these customers.

Contact centers keep track of various statistics, including the numbers of abandoned contacts, and there is always a wish to reduce this statistic as far as possible, because it represents the set of callers most dissatisfied with the level of service provided by the contact center. The present method allows customers to disconnect and reconnect, thereby also allowing the contact center to differentiate between truly abandoned contacts and those contacts which are only disconnecting temporarily.

In one scenario, the absentee contact takes the position in queue of a contact formerly associated with the customer.

Indeed, the absentee contact is preferably a modified version of the contact formerly associated with the customer.

Preferably, the absentee contact is only maintained for a finite period of time before being discarded. This prevents the system being clogged up with “dead” contacts, and if the customer knows that he or she needs to call back within a cut-off time period, then there will be more encouragement to resume contact with the contact center and not just simply to abandon calls.

Preferably, the absentee contact is progressed within the queue towards the top of the queue. This option represents the most attractive scenario for the customer—while disconnected, the contact progresses within the queue, without the need for the customer to wait on hold. The rate of progress can be the same as if the customer had not disconnected, or the rate of progress can be modified so that the contact progresses more slowly, at the option of the contact center operator. The rate need not be constant and can be varied based on factors such as the load on the contact center, position within the queue, priority assigned to the contact, and other factors.

In one embodiment, if the absentee contact reaches the top of the queue without a later communications session between said customer and said contact center having been detected, the absentee contact is returned to a predetermined starting position on at least the first occasion that the top of the queue is reached.

In this way, the customer can be assured that the position in the queue on reconnection will be, at worst, the position held at the time he or she disconnected.

Preferably, in such circumstances, a count is advanced on each occasion that the absentee contact reaches the top of the queue, the absentee contact being removed from the queue when the count reaches a predetermined value.

The contact center operator can decide how many times a contact can be looped back to its starting position in such a scenario. This limit can be combined with an absolute lifetime associated with the contact (e.g. the absentee contact is looped back to its starting position a maximum of three times before being removed from the queue, with the caveat that the contact is removed from the queue after, for example, 30 minutes in any event).

When the predetermined count value has been reached, the contact is removed from the queue, but it need not be deleted immediately. There may be an extended period during which the contact data is maintained so that, if the customer reconnects during this extended period, the absentee contact can be reinserted in the queue, perhaps at a less favorable position or at the beginning of the queue. This would still avoid the contact center having to determine which queue was most appropriate, and might avoid the necessity of the customer re-entering data or of passing through an automated interactive voice response (IVR) menu before being placed in a queue.

In an alternative scenario, if the absentee contact reaches the top of the queue without a later communications session between the customer and the contact center having been detected, the absentee contact is removed from the queue.

In this scenario, while the absentee contact is not looped back to its starting position, it may nevertheless be retained for a time allowing the customer to reconnect and still benefit from the stored data.

As a further alternative, if the absentee contact reaches the top of the queue without a later communications session between the customer and the contact center having been detected, the absentee contact is maintained at the top of the queue for a predetermined period.

The length of such a period will be determined by the contact center operator and may vary depending on the priority assigned to the contact, the time of day, the particular queue in question, the number of contacts in the queue, or any other suitable criterion.

As an alternative to moving within the queue, the absentee contact may be assigned a static queue position so it does not progress within the queue until a later communications session between the customer and the contact center has been detected.

This still provides the customer with some benefits, namely the ability to quickly rejoin the queue and the opportunity to disconnect for a time (e.g. if the customer cannot stay involved in a call for any reason). By holding a place in the queue, the customer is provided with a significant advantage relative to having to start afresh.

The “queue position” can be measured in many different ways, including expected wait time to top of queue, absolute position in queue measured from the top or from the beginning of the queue, or even in terms of percentage progression within the queue.

By percentage progression is meant that if a customer is, for example, in 120^{th} place from the top of the queue, with a total of 480 customers in the queue, then that customer may be considered to be 75% of the way along the queue, measured from the beginning of the queue towards the top of the queue. In another contact center, the customer may be determined to be 7 minutes away from the top of a queue which has an expected wait time of 28 minutes for a new contact joining the beginning of the queue: such a customer would similarly be 75% of the way towards the top of the queue. In such cases, if the customer were to disconnect and an absentee contact were to be associated with the queue in a static position, measured in such percentage terms, then upon rejoining the queue, the customer might be placed at the 75% point in the current queue. This would encourage a customer calling at a busy time (when the queue was e.g. 480 customers in length) to reconnect at a less busy time (when the queue is e.g. 200 customers in length), as the contact would be reinserted in the queue at the current 75% point, i.e. 50 places from the top of the queue. In the case where the 75% measurement was made in terms of wait time, supposing the customer reconnected when the queue wait time had reduced to 10 minutes, then the customer's 75% position would equate to a 2.5 minute wait. In this way customers are encouraged to balance the load of the contact center between a busy time and a less busy time. Preferably, the absentee contact includes a reference to information provided by the customer before having accepted the option to terminate, whereby the information may be associated with the later communications session without having to be provided again by the customer.

Thus, as indicated previously, data gathered in the initial communications session can be stored and re-used, in particular data provided by the customer to an automated system such as an IVR session, some other question-and-answer session, or to a series of forms which have to be filled in.

In some system designs, the absentee contact may not be placed in the contact queue at all, but instead is associated with the contact queue by reference, and the absentee contact is returned to the beginning of the queue upon associating the later communications session with the absentee contact.

Thus, the customer can be provided with the lesser benefit of being dropped from the queue and re-entered at the beginning of the queue. This can still provide the customer with a more favorable experience by allowing for a shorter queuing time if the customer calls back at a less busy time, and can provide the benefit of re-using the stored data without it being re-entered, as discussed above.

Preferably, the method further includes the step of communicating to the customer, on acceptance of the option, an identifier associated with the absentee contact.

Thus, the customer may be given a “ticket number” or some other identifier of the absentee contact. This provides the customer with a certain peace of mind in having confirmation that the absentee contact is created and is in the system. It may also allow the customer to provide this identifier to ensure that on reconnection the new session is associated correctly with the absentee contact.

Thus, the step of monitoring for a later communications session between the customer and the contact center preferably includes monitoring for receipt of the identifier in a later communications session.

Further, preferably, the step of monitoring for a later communications session between the customer and the contact center includes the step of providing a facility for a customer to communicate or input the identifier to a system of the contact center.

The step of communicating an identifier associated with the absentee contact may include generating the identifier from information associated with the customer and available to the contact center.

This has the advantage, if the information is familiar to the customer, of providing for an easily recalled identifier, making the system more user-friendly.

Preferably, in such cases, the identifier is generated to include elements of the customer's communications address.

Preferably, the communications address is selected from the group consisting of a telephone number, a session initiation protocol (SIP) address, an email address, an Internet protocol (IP) address, and an instant messaging (IM) address.

For example, if the customer is calling from a telephone number which is recognised by calling line ID recognition (or if the customer has entered this number), and such a customer chooses to disconnect but to have an absentee contact created, the system may by default assign an identifier consisting of the final four digits (say) of the customer's telephone number. In such a case, if there was a prior absentee contact still active in the system with that four digit identifier, then the last three or last five digits of the customer's telephone number could instead be used, or failing this, the system could use some other combination of digits.

Preferably, the step of communicating an identifier includes confirming to the customer an identifier provided by the customer to the contact center.

For example, the customer may select the option to disconnect and call back, with a guarantee of the same queue position, and in response the system may play back the following announcement: “Thank you. If you call back within the next 30 minutes, you will be re-entered in the queue at your current position. You may be asked for a ticket number when you call back. Your ticket number is the last four digits of your telephone number, that is six-five-four-three. You may now hang up, or press 1 to repeat this message.”

The ticket number can be provided in many other ways, such as by an SMS or text message to a caller on a mobile phone, by sending a new URL to a customer who is in contact by instant messaging, by sending an email, or in any other suitable way.

Preferably, the step of monitoring for a later communications session between the customer and the contact center includes monitoring for a communications session identifier which is associated with the customer.

Thus, the step of monitoring for the communications session identifier may involve prompting the customer for this identifier, which the customer may input using any input means appropriate to the contact medium, e.g. by typing, speaking, entering keypresses on a dialing pad, or selecting controls in a graphical user interface.

Monitoring for the identifier may also, where the identifier is a recognizable address or other characteristic of the earlier communications session, include recognizing this same address or characteristic in a later communications session and determining that the later session should be associated with a particular absentee contact. It will be appreciated that the identifier might be as simple as an IP address, a telephone number, or an instant messaging screen name, or it may be as sophisticated as a voice fingerprint or the visual appearance of a customer involved in a video session.

The invention also provides a computer program product in the form of a computer-readable medium carrying instructions which when executed in a computing system of a contact center, are effective to cause the computing system to:
maintain a contact queue for a resource, the queue including contacts associated with customers who are awaiting access to the resource;
provide a customer of the contact center with the option to terminate a communications session with the contact center without losing a benefit of the current communications session;
upon acceptance of the option by the customer, maintain an absentee contact associated with the customer and with the contact queue, the absentee contact including an identifier suitable to identify a later communications session from the customer;
monitor for a later communications session between the customer and the contact center; and
upon detecting the later communications session, associate the later communications session with the absentee contact.

The invention further provides a queuing system for a contact center, comprising:
a contact queue for a resource of the contact center, the contact queue including contacts associated with customers who are awaiting access to the resource;
an interface providing a customer of the contact center with the option to terminate a communications session with the contact center without losing a benefit of the current communications session;
a contact management system operable to maintain, upon acceptance of the option by the customer, an absentee contact associated with the customer and with the contact queue, the absentee contact including an identifier suitable to identify a later communications session from the customer; and
a monitoring system operable to monitor for a later communications session between the customer and the contact center;
whereby, upon the monitoring system detecting the later communications session, the contact management system associates the later communications session with the absentee contact.

The invention will now be illustrated by the following description of embodiments thereof, given by way of example only, with reference to the accompanying drawings, in which:

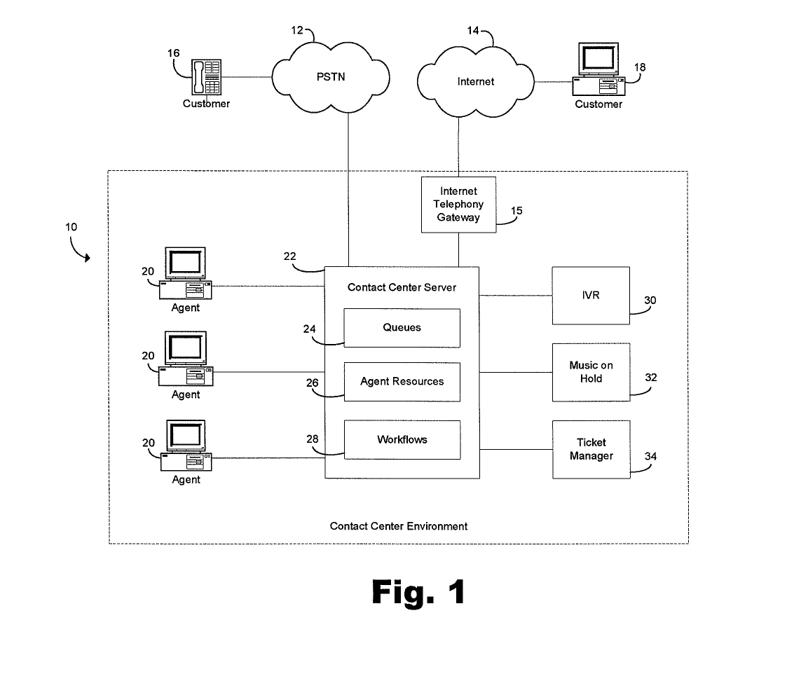

FIG. 1 is a block diagram architecture of a system including a contact center having an improved queuing system;

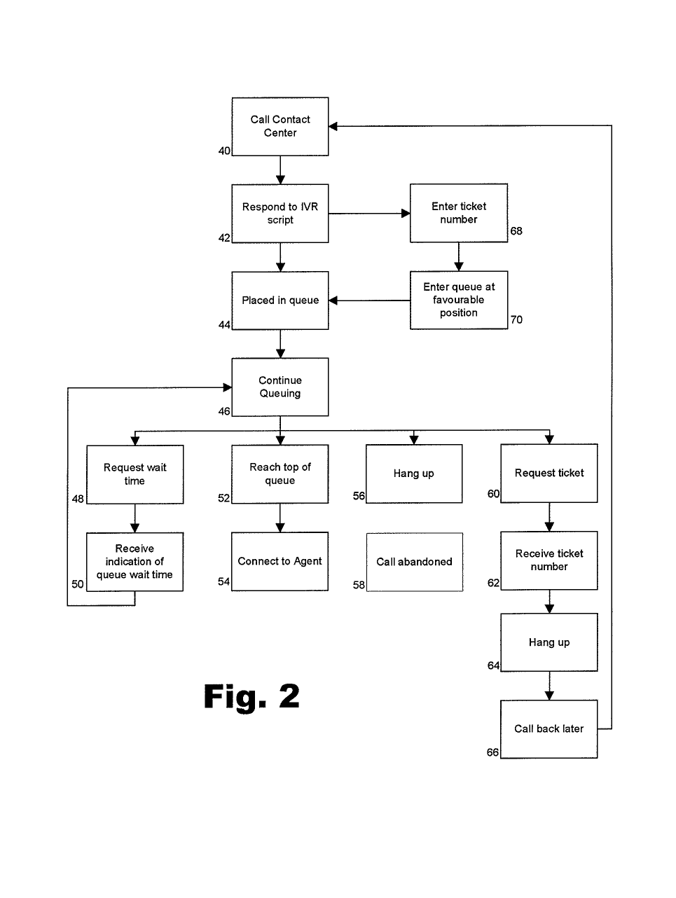

FIG. 2 is a flowchart of an improved queuing process, from the viewpoint of the customer;

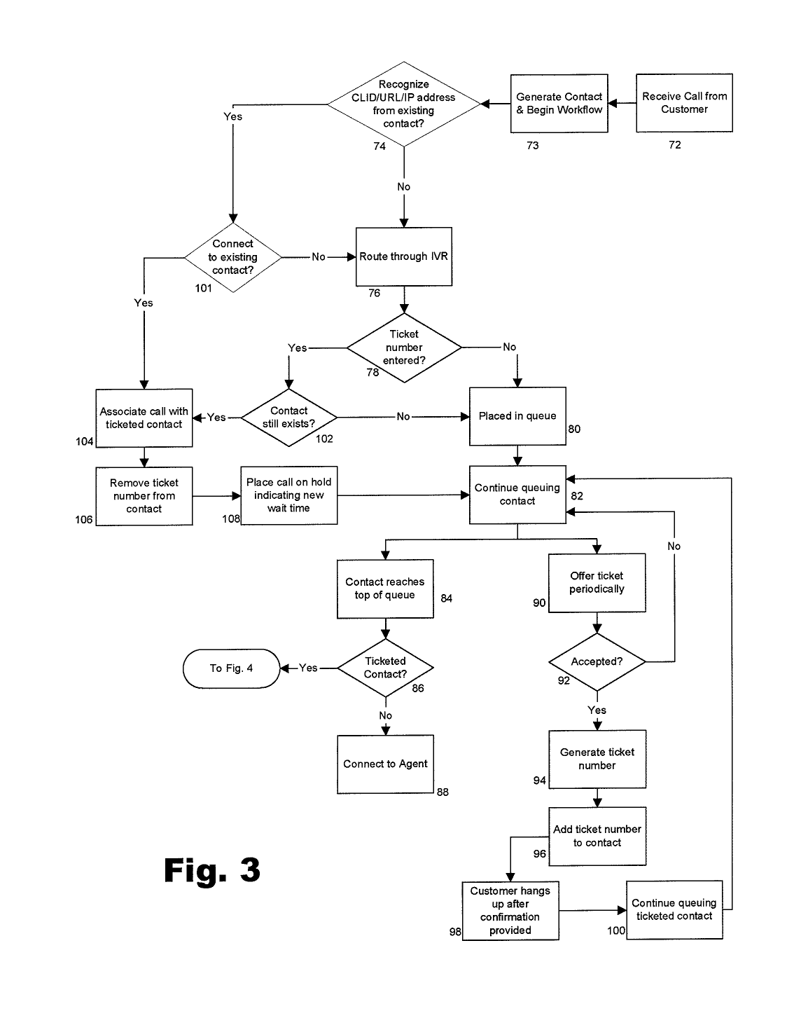

FIG. 3 is a flowchart of the process of FIG. 2, from the viewpoint of the contact center; and

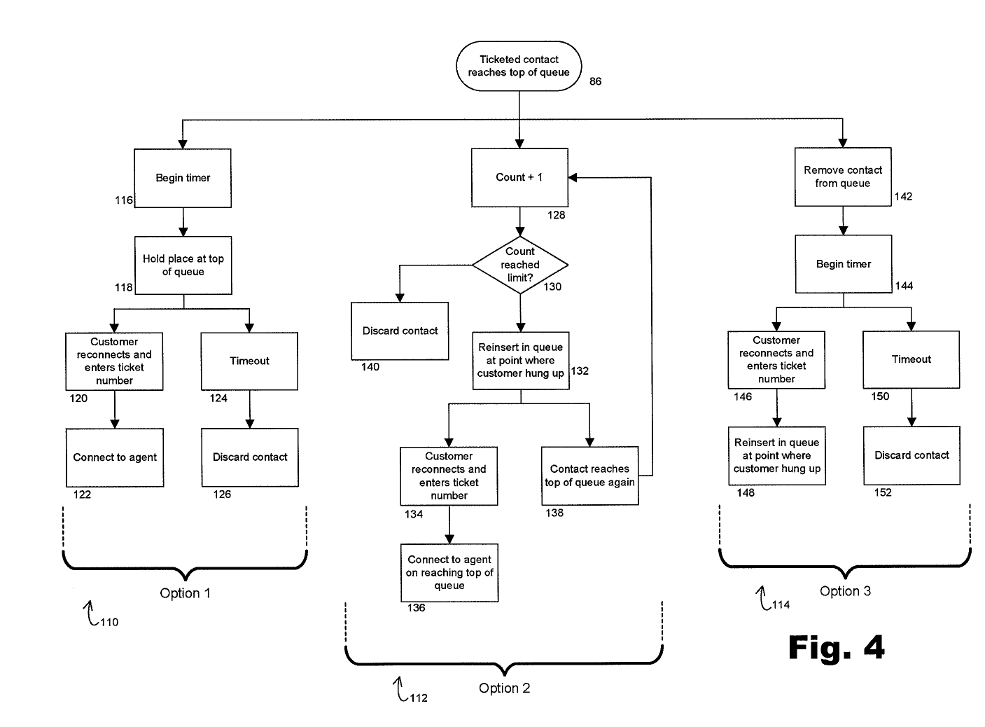

FIG. 4 is a flowchart illustrating three different choices for handling an absentee contact when it reaches the top of a queue.

In FIG. 1 there is indicated, generally at 10, a contact center connected to the public switched telephone network (PSTN) 12 and to the Internet 14. An Internet telephony gateway 15 is provided to translate between a private branch exchange (not shown) in the contact center and the Internet 14. Alternatively, the contact center may be enabled for voice over IP (VoIP) communications, such that direct telephony communications with the Internet may be made, and in such cases, translation between the VoIP environment of the contact center and the PSTN 12 will be mediated by appropriate equipment in known manner. Using the PSTN 12 and Internet 14, respectively, customers 16, 18 may connect to the contact center using conventional telephony equipment, as in the case of customer 16, or using Internet-enabled hardware or software, as in the case of customer 18 (e.g. dedicated voice or video Internet telephony equipment, or a computer with appropriate software for such telephony, or a computer with instant messaging software).

The contact center itself is, to a large extent, conventional, and the operation of such a contact center will be well known to the skilled person. Thus, for example, a plurality of agent workstations 20 are provided allowing human agents to service both incoming and outgoing contacts. While this embodiment is described only in relation to voice calls, the contact center will typically be a multimedia contact center serving contacts of different media types in addition to or instead of simple voice calls. For example, contact centers may service video calls, instant messaging (IM) sessions and emails, to provide but a few examples. Each agent workstation 20 is provided with suitable client software to enable contacts in the relevant media types to be presented to the agent. The client software will be integrated with, for example, telephony equipment or video equipment so that the agent is enabled to speak with the customers 16, 18 by voice or video link.

Communications sessions are handled by a contact center server 22 which operates a plurality of queues 24, which manages the agent resources 26, and which is programmed with workflows 28. In this way, an incoming call or contact from a customer 16, 18 is processed in accordance with the instructions contained in a workflow 28. Typically, this may involve placing the call in a conference with an interactive voice response (IVR) server 30 which plays recorded announcements to the customer and requests inputs from the customer. These inputs are stored and used by the contact center to traverse an IVR workflow until all relevant information has been gleaned from the client, and subsequently, to place the contact in one of the queues 24. Typically, this is done by assigning the contact to one or more skillsets, each skillset being serviced by an agent or group of agents with the requisite skills to handle queries relating to that skillset.

If an agent is free, the contact can be assigned directly to an agent (by manipulation of appropriate software objects in the queues 24 and agent resources 26), with the result that the customer is placed in conference with one of the agent, who can then deal directly with the questions or concerns of the customer. More typically, agent resources are limited and the contact is assigned to a skillset queue along with other contacts which are waiting for the same agent resources. The contacts are serviced according to various criteria including waiting time, priority, urgency, media type and so forth. When a contact reaches the top of the queue, it is assigned to the next available agent.

During the time that a contact is in a queue, the caller will typically be placed on hold and provided with entertainment, music, announcements, advertisement or other content, represented in FIG. 1 by music-on-hold server 32. It is not unusual in such circumstances to occasionally provide the customer with an indication of the position in queue or the wait time expected until an agent is free, or to allow the customer to request such information by making appropriate key presses or speaking appropriate key words.

In the system of FIG. 1, however, an additional option is make available to the customer by providing the customer with the option to “take a ticket”. Such “tickets” are allocated and managed by a ticket manager 34 which in fact manages the absentee contact types referred to previously. The operation of ticket manager 34 will now be described in more detail with reference to FIGS. 2 and 3.

Referring first to FIG. 2, when a customer calls the contact center, step 40, such a customer will, as described previously, typically make suitable responses to an IVR script, step 42 and in accordance with the responses given, the customer inputs will be represented by data added to a contact (i.e. a data file or software object) which is placed in a queue, step 44. In conventional operation of the contact center, the customer will continue queuing, step 46, until one of several events occurs.

For example, the customer may request to be informed of the current wait time, step 48. The contact center server will provide an indication of the current expected wait time from the customer's queue position, step 50, following which the customer continues to queue, step 46. Eventually, if the customer waits a sufficient length of time, the contact will reach the top of the queue, step 52, at which point the customer will be connected to an agent as previously described, step 54.

If the customer loses patience or refuses to remain on hold, the customer will hang up, step 56, and the contact center will record this as an abandoned call, step 58. An additional option is provided, not normally available in conventional contact centers, however, in that the customer may request a ticket, step 60 (or may be periodically offered a ticket while holding). A “ticket” in this sense is really the option to create a place holder of some sort, and more particularly an absentee contact, which records a benefit of the current communications session.

If a customer opts to request a ticket, step 60, the system provides the customer with a ticket number, played back to the customer in the form of an automated announcement, step 62, and the customer may then hang up, step 64.

If the customer chooses to call back later, step 66, then the customer will be directed, through steps 40 and 42 to an IVR script. One of the options provided in the script is the option to enter a ticket number, step 68, and when the customer does this, the ticket number is recognized by the system and a benefit is provided to the customer, in this case the benefit of entering the queue at a favorable position, step 70, or the re-use of stored data.

As indicated previously, the benefit may be to re-enter the queue at the position at which the customer left the queue, or to re-enter at a position which is more favorable (for example, as though the customer had continued to queue, i.e. with the absentee contact having been moved along in the queue as normal or at a different rate). The benefit may be that the customer is demoted to the beginning of the queue, but that all of the information gleaned during the initial IVR session, step 42, is retained and the customer is spared the necessity of having to re-enter all information and to provide the information again. Other benefits have been alluded to preciously and may also be provided.

It will therefore be appreciated that, from the point of view of the customer, as shown in FIG. 2, the option to request a ticket allows the customer to hang up and call back later while obtaining a benefit such as a more favorable queue position.

In the contact center, the same process is represented in FIG. 3. An initial call is received from the customer, step 72. The contact center management software generates a contact, i.e. a file or token or software object representing this communications session, and begins the workflow for incoming contacts, step 73.

A check is then made to see whether the customer's contact details (e.g. calling line identifier, or the URL used to contact the contact center, or the customer's IP address) are already associated with an existing contact, step 74. In the first iteration, no such existing contact will be present and therefore the process moves to step 76 as will be described immediately. Later iterations will be described further below, i.e. when the outcome of this determination in step 74 is positive.

In this example, the communications session is a voice call, and accordingly, it is routed through the interactive voice response system, as described previously, step 76. One of the options presented by the IVR system is for the customer to enter a ticket number, as indicated by the decision branch 78. As previously described, on the first iteration, no ticket number exists for the customer, and so the customer contact is placed in a queue, step 80, in accordance with the IVR responses obtained at step 76. The contact continues to queue, step 82 and, as indicated in FIG. 2, various events can occur while the contact queues. Two options are not shown in FIG. 3 for brevity, namely the options that the caller might hang up without having requested a ticket, or that the current place in queue or wait time is indicated to the caller either periodically or on request.

If the contact reaches the top of the queue, step 84, then a check is made to determine if this is a ticketed (absentee) contact, decision 86. Assuming that this is not such a contact, the call is connected to an agent in the normal way, step 88. The implications of an absentee or ticketed contact reaching the top of the queue will be described on the next iteration.

The alternative to the contact reaching the top of the queue in step 84 is that the customer accepts the offer of a ticket before being connected to an agent and before hanging up. Thus, in step 90, the customer is periodically offered a ticket while queuing, step 90. If this offer is not accepted, decision 92, the contact continues to queue, step 82. If, however, the customer does choose to accept a ticket, the ticket manager generates a ticket number, step 94. An absentee contact is then created by adding the ticket number to the existing contact in the queue, step 96.

As previously described, a confirmation of the ticket number is played back to the customer, step 98, following which the customer can hang up. Within the illustrated contact center process, while the communications session with the customer has been disconnected, the ticketed contact or absentee contact continues to be queued, step 100, and the process for this contact reverts back to step 82. The ticket number can also be provided in many other ways, such as by an SMS or text message to a caller on a mobile phone, by sending a new URL to a customer who is in contact by instant messaging, by sending an email, or in any other suitable way.

In the described embodiment of FIG. 3, the absentee contact is queued exactly as a normal contact would have continued to queue for an agent resource.

In this scenario, there are two possibilities. One is that the customer calls back before the absentee contact reaches the top of the queue, and the other option is that the absentee contact reaches the top of the queue before the customer calls back. Each option will be described in turn.

When a customer who already has been allocated a ticket number calls back into the contact center, step 72, a new contact is generated as normal, step 73. However, the customer may be using recognizable contact identifiers (CLID or URL or IP address, for example), according to which the new call is associated with the existing contact in decision 74. In such a case, the customer, having been recognized automatically, is given the option, step 101, to connect to the existing queued contact from the earlier communications session. If the customer chooses not to be so connected, then the call is routed to IVR as normal, step 76 (just as the call would have been if the customer were calling from an unrecognized source). Such a customer can still choose to enter a different ticket number in step 78.

This sequence of events might occur if, for example, a number of employees of the same organization were in contact with a sales support contact center. A first such employee might choose to hang up and take a ticket with the intention of calling back later. A second employee, if the calling line ID was the same, might then be falsely associated with the queued, ticketed contact. The second employee has the option, however, of refusing the association in step 101 and instead is routed through IVR in step 76. If that second employee has already taken a ticket as well in an earlier call, then step 78 allows that second employee to identify her own ticket.

On determining that this new communications session may have a ticketed contact associated with it (due to entry of the ticket number or to some other determination), the system then determines, in decision 102, whether the contact still exists. If the customer has delayed for too long a period before calling back, the absentee contact may have been discarded or deleted.

In such a case, the new contact generated for the customer in step 74 is simply placed into a queue as normal, step 80.

If, however, the absentee contact is determined to still exist in decision 102, this new communications session is associated with this ticketed contact or absentee contact, step 104. At this point, the ticketed contact will represent a live communications session with the customer, just like all other conventional contacts in the queue, and accordingly the ticket number will have served its purpose and can be removed from the contact, step 106. At the same time, the new contact generated in step 74 of this communications session can be discarded as it is no longer needed, the customer having a “better” contact in the form of the ticketed contact in the queue. Once the ticket has been removed from the contact, the new call can be placed on hold, step 108, with the contact center indicating the new wait time to the customer, and the contact continues to queue, step 82, as normal. From the point of view of the customer, the new communications session or call has been re-inserted in the queue at a more favorable position than before. When this contact reaches the top of the queue, it will not be marked as a ticketed contact in decision 86, and thus the customer will be connected directly to an agent.

In the other option, as mentioned previously, the ticketed contact may reach the top of the queue before the customer has called back (and indeed the customer may never call back). Three of the options available to a system designer in this scenario are indicated in FIG. 4, with “option 1” indicated generally at 110 (left-hand section of FIG. 4); “option 2” indicated generally at 112 (middle section of FIG. 4); and “option 3” indicated generally at 114 (right-hand section of FIG. 4).

In option 1, the ticketed contact or absentee contact is held at the top of the queue for a finite period of time. Thus, at step 116 a timer begins when the ticketed contact reaches the top of the queue, and the place at the top of the queue is held until one of two events occurs. The first event, step 120, is that the customer reconnects and enters the ticket number (or in some other way, the monitoring systems of the contact center determine that the customer has reconnected in a new communications session and that there is an associated absentee contact). In this case, the customer is connected to the agent, step 122.

Alternatively, a timeout may be reached, step 124, before the customer has reconnected. In this scenario, as indicated in step 126, the contact is simply discarded. Alternatively, the contact could be demoted back to the bottom of the queue, or the IVR details gleaned from the first communications session could be extracted from the contact and saved for later use, while discarding the contact from the queue.

In the second option, as indicated generally at 112, when the ticketed contact reaches the top of the queue, a counter is initiated and advanced by 1 (to an initial value of 1), step 128. The system maintains a predetermined limit for this count, and checks on each iteration whether this limit is reached (which it will not be on the first iteration), decision 130.

The count limit not having been reached, the contact is reinserted in the queue at the point at which the customer hung up. Thus, if the customer was in, for example, fortieth position from the top of the queue at the point when they hung up, the contact may be reinserted at that point. Alternatively, if the customer was determined to be 75% of the way through the queue, then the contact can be reinserted at the 75% mark (however this has been measured) in the current queue, step 132. Again there are two possible outcomes as the reinserted absentee contact moves along the queue following step 132. Firstly, the customer may reconnect and enter the ticket number, step 134, in which case the customer will be connected to the agent upon reaching the top of the queue, step 136. Alternatively, the contact can reach the top of the queue again without the customer having been reconnected, step 138, and in this case, the process reverts to step 128, namely the counter is advanced by 1 and a check is make whether the count limit has been reached, decision 130. When the absentee contact has moved through the top of the queue a predetermined number of times, as indicated by the count limit, the contact is discarded, step 140. Again, instead of simply deleting the contact, the details from the contact can be saved for later re-use if the customer should reconnect, or the contact could be moved to a less advantageous queue position, such as the beginning of the queue.

The third option, indicated generally at 114, is that when the contact reaches the top of the queue in step 86, it is simply removed from the queue immediately, step 142. It is not, however, deleted, and it is saved in memory. At this point, a timer is started, step 144. As in the case of option 1, the customer may reconnect before a timeout is reached, step 146, and upon recognizing the later communications session from the customer as relating to this absentee or ticketed contact, the absentee contact may be reinserted in the queue at the point where it was when the customer first hung up, step 148.

Alternatively, if a timeout is reached, step 150, before the customer has reconnected, the contact can simply be discarded, step 152. In this case, the benefit accruing to the customer is the possibility of reconnecting within a specified time without losing a place in the queue, since from the customer's viewpoint, upon reconnection within this timeout period, the absentee contact will either be progressing towards the top of the queue on its first iteration, or will be held in memory for reinsertion into the queue at the point where the customer hung up.

It will be appreciated that various alternative options can be provided for handling an absentee contact, in accordance with the priorities of the operator of the contact center. Different variations on the options shown in FIGS. 2, 3 and 4 can be provided based on a priority level or identifier of the customer (i.e. some customers can be treated more favorably than others), and indeed the option to request a ticketed contact may only be provided to a subset of customers. The options may also be limited to specific queues or skillsets, for example.

It will be appreciated that the processes outlined in the preferred embodiments are typically implemented in software, as are the functional blocks indicated in FIG. 1. Such software may be implemented in any suitable programming language, and can be operated on any suitable programming device capable of managing the queuing systems of a contact center. It is to be understood that no limitation to a particular hardware or software implementation is required in order to accrue the benefits provided by the invention.

The invention is not limited to the embodiments described herein which may be modified without departing from the spirit and scope of the claimed invention.

What is claimed is:

1. A method of operating a queuing system of a contact center, comprising the steps of:
maintaining a contact queue for a resource, said queue including contacts associated with customers who are awaiting access to said resource;
providing a customer of the contact center with the option to terminate a communications session with the contact center without losing a benefit of the current communications session;
upon acceptance of said option by said customer, maintaining an absentee contact associated with said customer and with said contact queue, said absentee contact including an identifier suitable to identify a later communications session from said customer;
monitoring for a later communications session between said customer and said contact center; and
upon detecting said later communications session, associating said later communications session with said absentee contact.

2. A method as claimed in claim 1, wherein said absentee contact takes the position in queue of a contact formerly associated with said customer.

3. A method as claimed in claim 2, wherein said absentee contact is a modified version of said contact formerly associated with said customer.

4. A method as claimed in claim 1, wherein said absentee contact is only maintained for a finite period of time before being discarded.

5. A method as claimed in claim 1, wherein said absentee contact is progressed within the queue towards the top of the queue.

6. A method as claimed in claim 5, wherein if said absentee contact reaches the top of the queue without a later communications session between said customer and said contact center having been detected, said absentee contact is returned to a predetermined starting position on at least the first occasion that the top of the queue is reached.

7. A method as claimed in claim 6, wherein a count is advanced on each occasion that said absentee contact reaches the top of the queue, said absentee contact being removed from the queue when said count reaches a predetermined value.

8. A method as claimed in claim 5, wherein if said absentee contact reaches the top of the queue without a later communications session between said customer and said contact center having been detected, said absentee contact is removed from the queue.

9. A method as claimed in claim 5, wherein if said absentee contact reaches the top of the queue without a later communications session between said customer and said contact center having been detected, said absentee contact is maintained at the top of the queue for a predetermined period.

10. A method as claimed in claim 2, wherein said absentee contact is assigned a static queue position and does not progress within the queue until a later communications session between said customer and said contact center has been detected.

11. A method as claimed in claim 1, wherein said absentee contact includes a reference to information provided by said customer before having accepted said option, whereby said information may be associated with said later communications session without having to be provided again by the customer.

12. A method as claimed in claim 1, wherein said absentee contact is not placed in said contact queue but is associated with said contact queue by reference, and wherein said absentee contact is returned to the beginning of the queue upon associating said later communications session with said absentee contact.

13. A method as claimed in claim 1, further comprising the step of communicating to said customer, on acceptance of said option, an identifier associated with said absentee contact.

14. A method as claimed in claim 13, wherein said step of monitoring for a later communications session between said customer and said contact center comprises monitoring for receipt of said identifier in a later communications session.

15. A method as claimed in claim 13, wherein said step of monitoring for a later communications session between said customer and said contact center comprises the step of providing a facility for a customer to communicate said identifier to said contact center.

16. A method as claimed in claim 13, wherein said step of communicating an identifier associated with said absentee contact comprises generating said identifier from information associated with said customer and available to said contact center.

17. A method as claimed in claim 16, wherein said identifier is generated to include elements of the customer's communications address.

18. A method as claimed in claim 17, wherein said communications address is selected from the group consisting of a telephone number, a session initiation protocol (SIP) address, an email address, an Internet protocol (IP) address, and an instant messaging (IM) address.

19. A method as claimed in claim 13, wherein said step of communicating an identifier comprises confirming to the customer an identifier provided by the customer to the contact center.

20. A method as claimed in claim 1, wherein said step of monitoring for a later communications session between said customer and said contact center comprises monitoring for a communications session identifier which is associated with said customer.

21. A computer program product comprising a computer-readable medium carrying instructions which when executed in a computing system of a contact center, are effective to cause said computing system to:
maintain a contact queue for a resource, said queue including contacts associated with customers who are awaiting access to said resource;
provide a customer of the contact center with the option to terminate a communications session with the contact center without losing a benefit of the current communications session;
upon acceptance of said option by said customer, maintain an absentee contact associated with said customer and with said contact queue, said absentee contact including an identifier suitable to identify a later communications session from said customer;
monitor for a later communications session between said customer and said contact center; and
upon detecting said later communications session, associate said later communications session with said absentee contact.

22. A queuing system for a contact center, comprising:
a contact queue for a resource of the contact center, said contact queue including contacts associated with customers who are awaiting access to said resource;
an interface providing a customer of the contact center with the option to terminate a communications session with the contact center without losing a benefit of the current communications session;
a contact management system operable to maintain, upon acceptance of said option by said customer, an absentee contact associated with said customer and with said contact queue, said absentee contact including an identifier suitable to identify a later communications session from said customer; and
a monitoring system operable to monitor for a later communications session between said customer and said contact center;
whereby, upon said monitoring system detecting said later communications session, said contact management system associates said later communications session with said absentee contact.
